(19) United States
(12) Patent Application Publication
(10) Pub. No.: US 2014/0254398 A1
(43) Pub. Date: Sep. 11, 2014

(54) Methods And Apparatus for Internetworking

(71) Applicant: NOKIA CORPORATION, Espoo (FI)

(72) Inventors: Zexian Li, Espoo (FI); Cassio Barboza Ribeiro, Espoo (FI); Esa M. Malkamaki, Espoo (FI); Antti S. Sorri, Helsinki (FI)

(73) Assignee: NOKIA CORPORATION, Espoo (FI)

(21) Appl. No.: 13/785,424

(22) Filed: Mar. 5, 2013

(51) Int. Cl. H04W 28/02

(52) U.S. Cl. CPC H04W 28/0231
USPC 370/252; 370/329

(57) ABSTRACT

Systems and techniques for data traffic management are described. A base station providing data communication services to user devices and capable of transferring traffic to one or more wireless network access points receives data queuing latency information relating to data queuing latency experienced by the one or more user devices, access points, or both. The base station makes determinations relating to offloading of traffic to access points, such as from wireless cellular network frequencies to wireless local area network resources, based on the latency information.

### TECHNICAL FIELD

The present invention relates generally o wireless communication. More particularly, the invention relates to improved systems and techniques for the use of latency measurements for management of offloading of network traffic.

### BACKGROUND

As the number of wireless cellular data communication devices continues to increase and as their data capabilities continue to be more and more heavily used, the demands on the available frequencies dedicated to cellular data communication comes closer and closer to saturation. One approach to the management of traffic load is the offloading of traffic onto unlicensed frequencies, such as those used by wireless local area networks (WLAN), whose presence may be represented by one or more access points (APs). Network operators may implement wireless network infrastructure, which uses unlicensed frequencies, and manage the transfer of traffic between base stations using licensed frequencies and unlicensed network access points. Such an approach may be used, for example, by 3rd Generation Partnership Project (3GPP) long term evolution (LTE) or LTE-advanced (LTE-A) networks. The efficient use of unlicensed frequencies and the efficient transfer of traffic between licensed frequencies and access points using unlicensed frequencies has the potential to greatly increase wireless data capacity.

### SUMMARY

In one embodiment of the invention, an apparatus comprises at least one processor and memory storing computer program code. The memory storing the computer program code is configured to, with the at least one processor, cause the apparatus to at least receive packet queuing latency information relating to data traffic between a user device and a wireless local area network access point and determine allocation of communication traffic to the wireless local area network access point based on the at least one packet queuing latency measurement.

In one embodiment of the invention, an apparatus comprises at least one processor and memory storing computer program code. The memory storing the computer program code is configured to with the at least one processor, cause the apparatus to at least configure measurement of packet queuing latency between a user device and a wireless local area network access point and cause transmission of measurement information to a base station making a determination relating to offloading data traffic to the wireless local area network access point.

In another embodiment of the invention, a method comprises receiving packet queuing latency information relating to data traffic between a user device and a wireless local area network access point and determining allocation of communication traffic to the wireless local area network access point based on the at least one packet queuing latency measurement.

In another embodiment of the invention, a method comprises configuring measurement of packet queuing latency between a user device and a wireless local area network access point and causing transmission of measurement information to a base station making a determination relating to offloading data traffic to the wireless local area network access point.

In another embodiment of the invention, a computer-readable medium stores a program of instructions. Execution of the program of instructions by a processor configures an apparatus to at least receive packet queuing latency information relating to data traffic between a user device and a wireless local area network access point and determine allocation of communication traffic to the wireless local area network access point based on the at least one packet queuing latency measurement.

In another embodiment of the invention, a computer-readable medium stores a program of instructions. Execution of the program of instructions by a processor configures an apparatus to at least configure measurement of packet queuing latency between a user device and a wireless local area network access point and cause transmission of measurement information to a base station making a determination relating to offloading data traffic to the wireless local area network access point.

In another embodiment of the invention, an apparatus comprises means for receiving packet queuing latency information relating to data traffic between a user device and a wireless local area network access point and means for determining allocation of communication traffic to the wireless local area network access point based on the at least one packet queuing latency measurement.

In another embodiment of the invention, the apparatus comprises means for configuring measurement of packet queuing latency between a user device and a wireless local area network access point; and means for causing transmission of measurement information to a base station.

### BRIEF DESCRIPTION OF THE DRAWINGS

FIG. 1 illustrates a graph illustrating throughput gains that can be achieved through offloading of wireless network traffic to WLANs;

FIG. 2 illustrates a graph illustrating the relationship between packet queuing delay and the number of WLAN active users under different conditions;

FIG. 3 illustrates a wireless network according to an embodiment of he present invention;

FIG. 4 illustrates a process according to an embodiment of the present invention;

FIGS. 5 and 6 illustrate reporting procedures according to embodiments of the present invention;

FIG. 7 illustrates a packet data unit including a timestamp according to an embodiment of the present invention; and

FIG. 8 illustrates elements for carrying out embodiments of the present invention.

### DETAILED DESCRIPTION

Embodiments of the present invention recognize that offloading of data traffic to a wireless network, such as a wireless local area network (WLAN) made much more effective if decisions about when to offload traffic to WLAN and when traffic can no longer be offloaded to WLAN are properly guided. Embodiments of the invention further recognize that overall WLAN latency can be used as a criterion for making offloading decisions, and can generally be relied on to be proportional to the number of users.

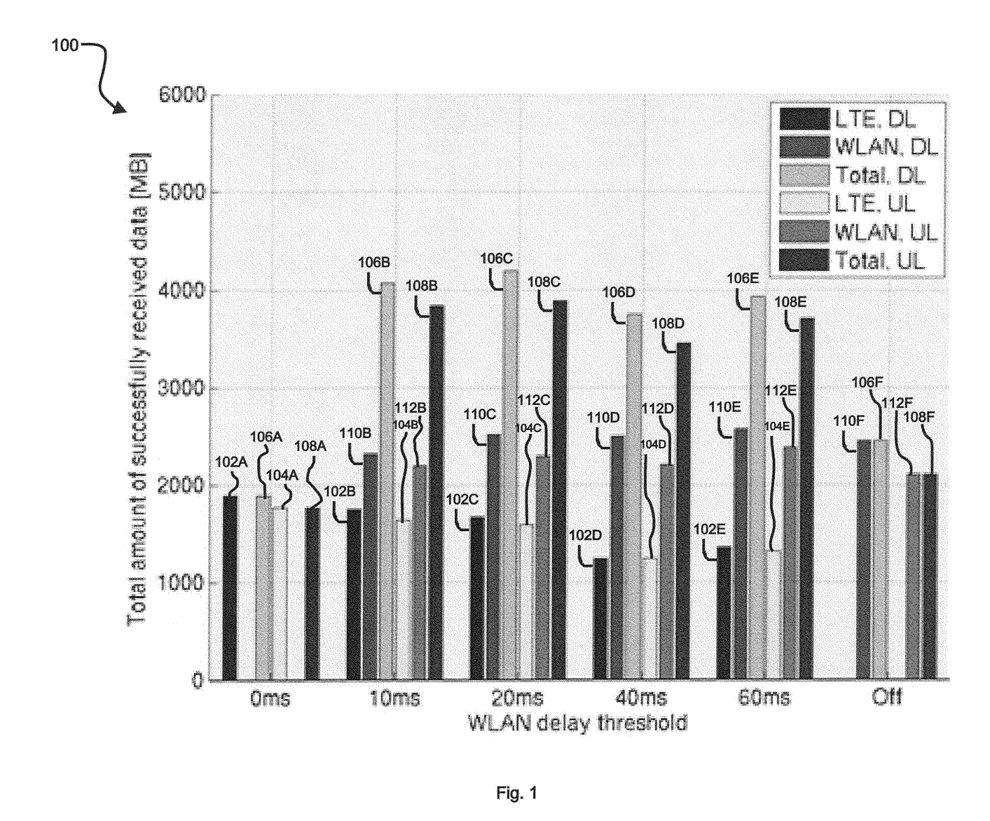

FIG. 1 illustrates a chart 100 showing throughput that can be achieved by varying levels of WLAN offloading with the criteria for offloading expressed in various delay thresholds. The plots 102A-102E illustrate LTE downlink throughput for a delay threshold of 0, 10, 20, 40, and 60 ms, respectively, the plots 104A-104E illustrate LTE uplink throughput, the plots 106A-106F illustrate total downlink throughput, and the plots 108A-108F illustrate total uplink throughput. No WLAN participation is shown for the 0 ms threshold, because a 0 delay threshold is not achievable so that no offloading occurs. However, WLAN participation is illustrated by the plots 110B-110F and 112B-112F for the thresholds ranging from 10 ms through 60 ms and for no threshold. If no threshold is used, all traffic is offloaded to the WLAN elements, so that the total throughput represents WLAN throughput.

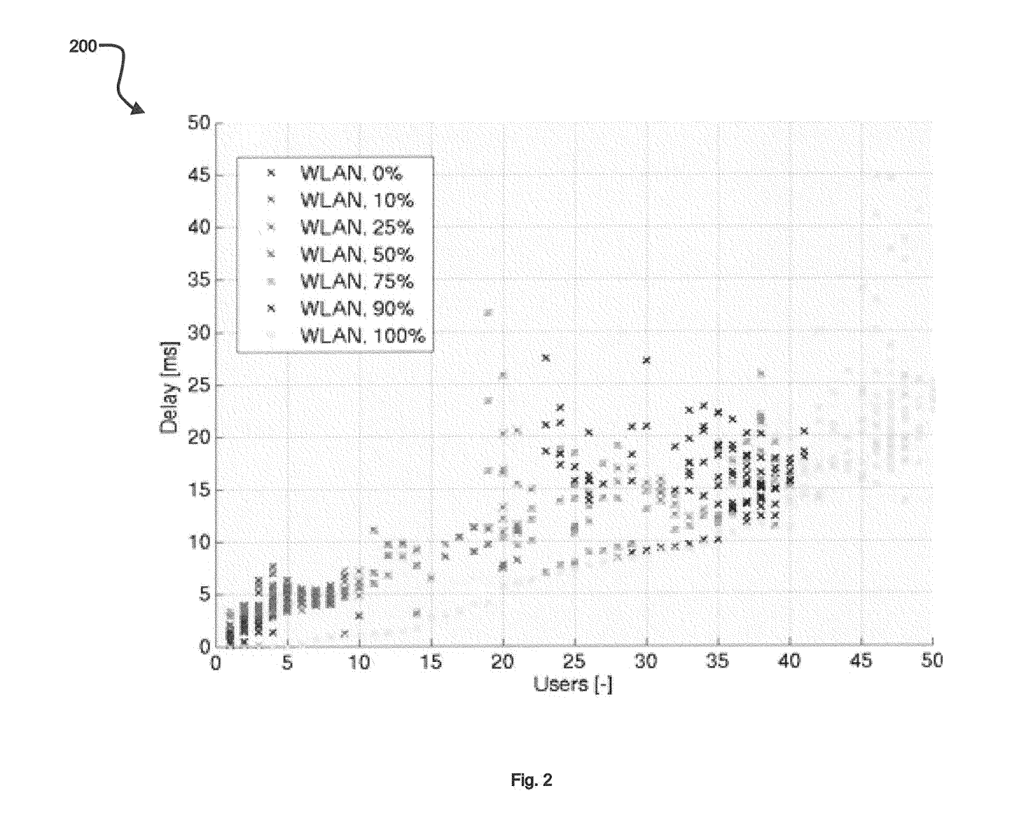

FIG. 2 illustrates a graph 200 showing a plot of latency, expressed in terms of queuing delay, plotted against the number of active users, for different proportions of WLAN usage. Latency represents overall packet queuing latency, which is the packet queuing latency from a WLAN access point (AP) and all user devices connected to it. In a system such as a 3rd Generation Partnership Project (3GPP) long term evolution (LTE) or LTE-advanced (LTE-A) system, the user device may be referred to as a user equipment (UE). The use of both uplink and downlink measurements is greatly beneficial for determining latency. In downlink, measurements may be measured at the WLAN AP, which may be communicated to a base station. The base station may be implemented as an eNodeB (eNB). The measurements may be communicated to an eNB. Such communication may be accomplished, for example, through a proprietary interface, through a core network, or via IP connectivity. In an uplink, measurements are obtained by the UEs, but such information is not generally available at the wireless LAN access point.

Embodiments of the invention therefore provide mechanisms for determining uplink packet queuing latency for different UEs connected to the same access point. A wireless network and an eNB may have a connection, which may be either logical or physical, allowing exchange of downlink latency information between the AP and the eNB. Embodiments of the invention also provide mechanisms allowing either or both of an eNB or a WLAN AP to receive information on a UE's queuing latency information in the uplink direction during a WLAN connection.

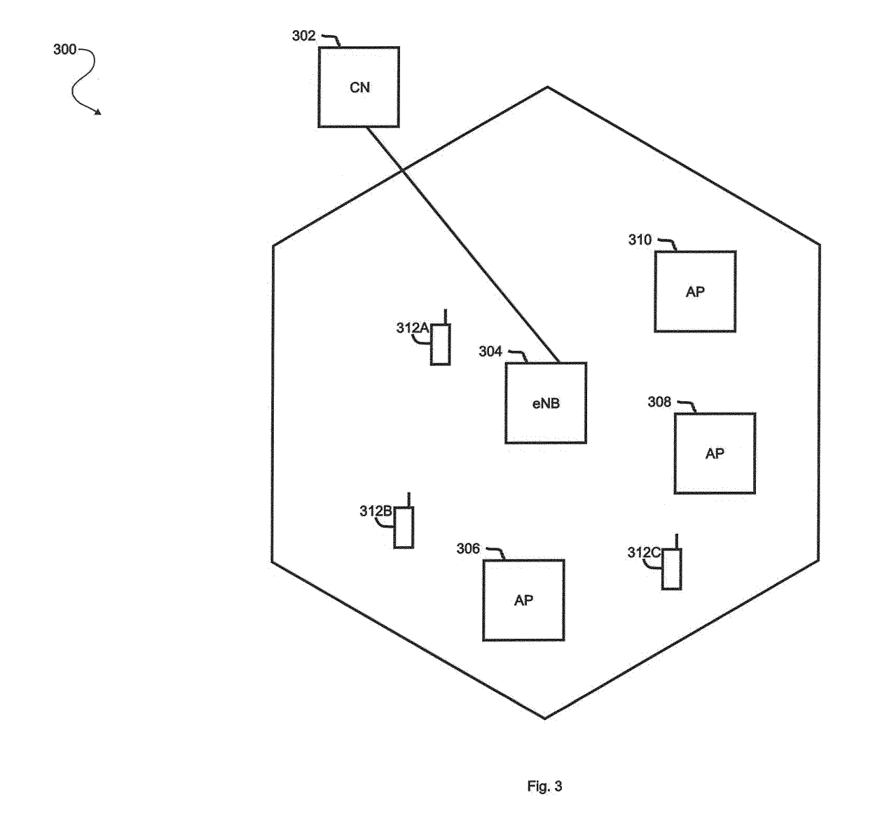

FIG. 3 illustrates a wireless network 300 according to an embodiment of the present nvention. The network 300 includes a core network 302. eNB 304. and access points 306, 308, and 310. The network 300 supports UEs 312A-312E, and is able to offload traffic from the eNB 304 to one or more of the access points 306, 308, and 310. The eNB 304 makes offloading decisions based on packet queuing latency measurements, including devices connected to WLAN APs. The eNB 302 may collect packet queuing latency information from UEs connected to the same WLAN AP and from the connected WLAN APs themselves. For example, if the macro eNB is determining whether o offload the traffic of the UE 312C to the AP 306, the eNB 302 may collect packet queuing latency information from the UE 312A and 312B and the AP 306, provided that UE 312A and UE312B have offloaded traffic via the AP 306. The eNB makes the offloading decision based on the collected latency information. In at least one embodiment of the invention, latency information ion is delivered to the eNB 302 by UEs, rather than by APs or UEs plus APs.

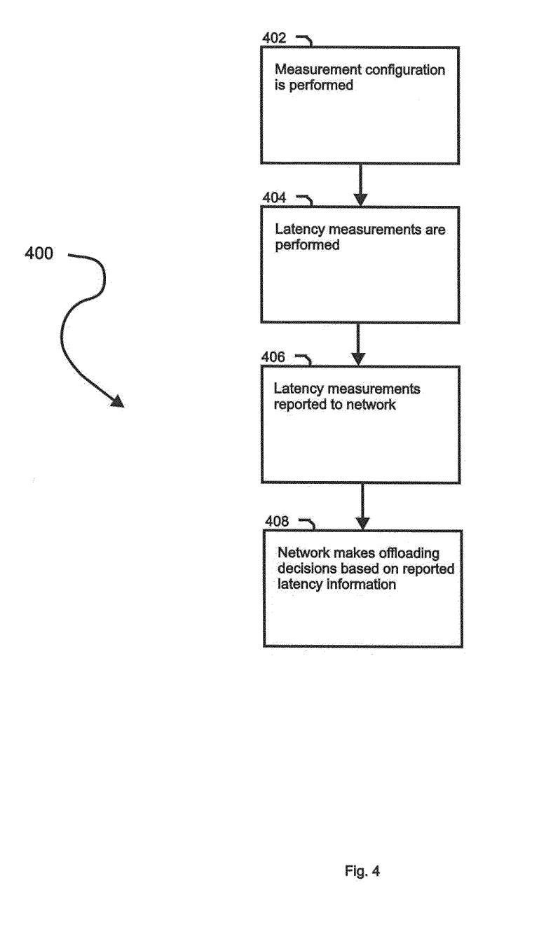

FIG. 4 illustrates a process 400 of traffic management according to one or more embodiments of the present invention. The process 400 comprises measurement configuration, actual latency measurement, reporting of latency information to a network, and making and carrying out of offloading decisions by the network.

At block 402, a measurement configuration is performed. For example, in the case of the network 300, a measurement configuration may be determined that is applicable for a UE in a radio resource control connected (RRC_CONNECTED) state by means of dedicated signaling, such as through the use of an RRCConnectionReconfiguration message defined in the 3GPP technical specification 36.331. Such configuration may include, for example, a trigger for measuring WLAN packet queuing latency, an indication of whether the measurement is periodic or non-periodic, and measurement triggers for a non-periodic measurement, or the periodicity for a periodic measurement.

One example of WLAN packet queuing latency may be a delay starting when a device has a non-empty transmit media access control (MAC) buffer and stopping when data extracted from the buffer (that is, when the device has a transmit opportunity or when the device has successfully transmitted the packet).

At block 404, latency measurements may be performed at one or more of the UEs and/or the WLAN AP or APs being considered for offloading. The WLAN latency in the uplink direction may be measured at the UEs, while the measurement in the downlink direction may be carried out at WLAN APs. The AP may report its downlink direction measurements to the UEs, and receiving such information enables the UEs to report both uplink and downlink latency information to the network.

At block 406, latency measurements are reported to a network—for example, to an eNB making offloading decisions for UEs whose traffic is being considered for offloading and for WLAN APs being considered for being assigned the traffic. At step 408, the network makes offloading decisions based on the reported measurement information.

The WLAN APs of interest and one or more UEs connected to WLAN APs of interest may report measurement results according to a measurement configuration such as that described above. As an example of event triggering, measurements may be requested when the WLAN load exceeds a specified threshold. If the WLAN load is too low and little interference is present, reports may not be necessary, particularly if the maximum tolerable latency in the WLAN is not set too strictly. Such an approach allows a network to optimize the signaling load, taking into account the tradeoff between the number of reports, the number of triggered measurements, and the accuracy of measurements.

A UE may report latency measurements using, for example. a long term evolution radio resource control (LTE RRC) measurement report. A suitably designed and configured AP is able to pass the report to the LTE network through a direct interface, such as a proprietary interface. operator backhaul, or other appropriate mechanisms. In one or more embodiments, the eNB and the AP may be elements or functions of the same physical structure, in which case communication between the eNB function and the WLAN function may be implemented as a part of the design of the structure.

The eNB may collect packet queuing latency reports for uplink latency from one or more UEs connected to the same AP. and from the AP itself for downlink latency. At block 408, the eNB may make decisions about WLAN offloading for current and upcoming bearers, with the decisions being based on the reported latency information.

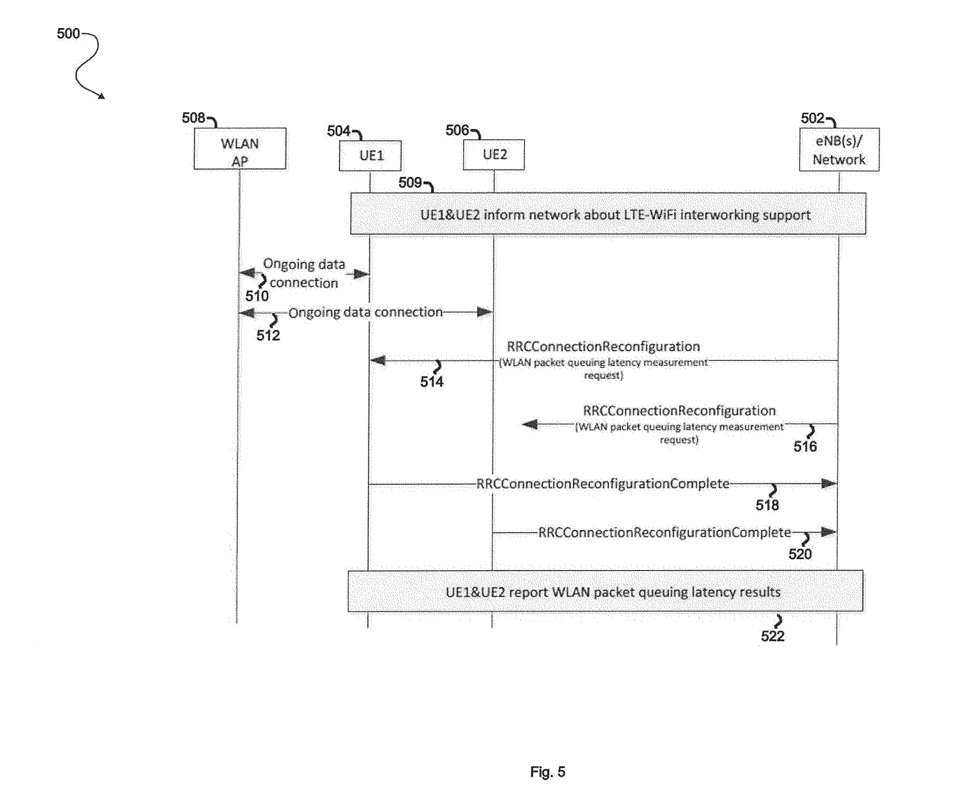

FIG. 5 illustrates a procedure 500 of packet queuing latency reporting by UEs, according to an embodiment of the present invention, illustrating various elements involved in the procedure and signal and data exchanges between the various elements. Latency reporting by UEs may suitably be performed for uplink latency, because appropriate measurements may be made by UEs. In addition, UEs are able to receive downlink latency information from an AP, An AP, for example, may broadcast latency information, or such latency information may be requested from an AP by a UE.

The procedure 500 includes operations carried out by a wireless network 502. embodied by one or more eNBs, a first UE 504, a second UE 506, and a WLAN AP 508. The wireless network 502 may suitably be a 3GPP LTE network.

The UEs 504 and 506 may be connected to the network 502, and may perform communication 509 informing the network 502 that internetworking support is available, allowing for offloading of LTE traffic to WLAN.

A first ongoing data connection 510 is established between the AP 508 and the first UE 504, and a second ongoing data connection 512 is established between the AP 508 and the second UE 506. The network 502, may, for example, be represented by a single eNB in the vicinity of the AP 508 and the UEs 504 and 506, and by other eNBs in the vicinity of other elements, The network 502 may make WLAN packet queuing latency requests 514 and 516 to the UEs 504 and 506, respectively. The requests may come in the form of RRCConnectionReconfiguration messages, which may provide measurement configuration information, such as configuration of measurements as periodic or non-periodic, configuration of periodicity of periodic measurements, and definitions of triggering events for non-periodic measurements. The UEs 504 and 506 may return indications that the requests have been received and acted on. These indications may take the form of RRCConnectionReconfigurationComplete messages 518 and 520.

The UEs 504 and 506 may then report WLAN packet queuing latency results in a communication 522, encompassing information exchange between each of the UEs 504 and 506, and the network 502. The WLAN packet queuing latency results may include uplink latency information measured by the UE itself, and may also include downlink communication which may be measured by the access point and delivered to the UE.

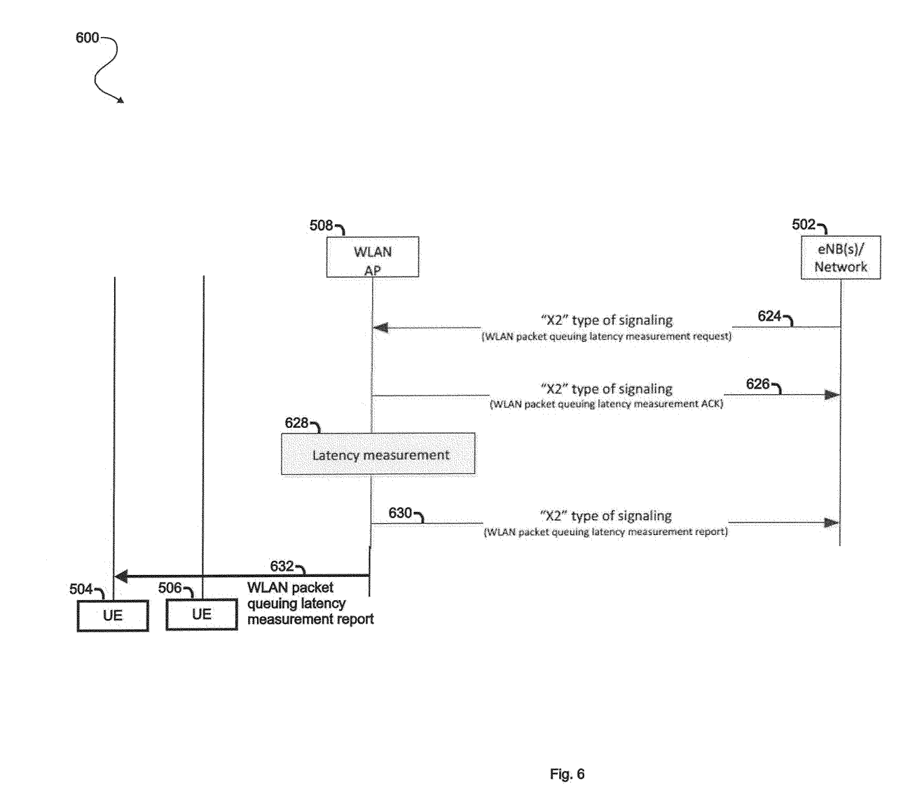

FIG. 6 illustrates a procedure 600 of access point reporting according to one or more embodiments of the present invention. The procedure 600 may include operations performed by the network 502 and the AP 508. The network 502 may transmit a WEAN packet queuing latency measurement request 624 to the AP 408. As an example, transmission may be accomplished using X2 signaling. It will be recognized, however, that any suitable communication mechanism may be used.

The AP 508 may respond by transmitting a WEAN packet queuing latency measurement acknowledgement 626 to the network 502. As an example, the transmission may be accomplished using X2 signaling. The AP 508 may then perform a latency measurement 628 and may transmit a WLAN packet queuing latency measurement report 630 to the network 502, As an example, transmission may be accomplished using X2 signaling to the network 502. In addition, the AP 508 may transmit a WLAN packet queuing latency measurement report to one or more UEs such as the UEs 504 and 506, which are then able to provide both uplink information based on their own measurements, and downlink reports based on the reports they have received from the AP 508. As noted above, once a network, suitably represented by one or more eNBs determining whether to offload traffic receives measurement reports such as those described above, each eNB making such a determination makes an offloading decision based on the reports. Mechanisms for both uplink latency reporting and downlink latency reporting are described above, and numerous alternative or additional mechanisms for latency reporting may be employed. Depending on the particular network design and configuration, one or both of uplink and downlink reporting may be employed, and eNBs may make offloading decisions based on available reporting. Generally, offloading decisions will be more accurate if both uplink and downlink latency information is available, but if only uplink or downlink information is available, decisions may be made based on the available category of information.

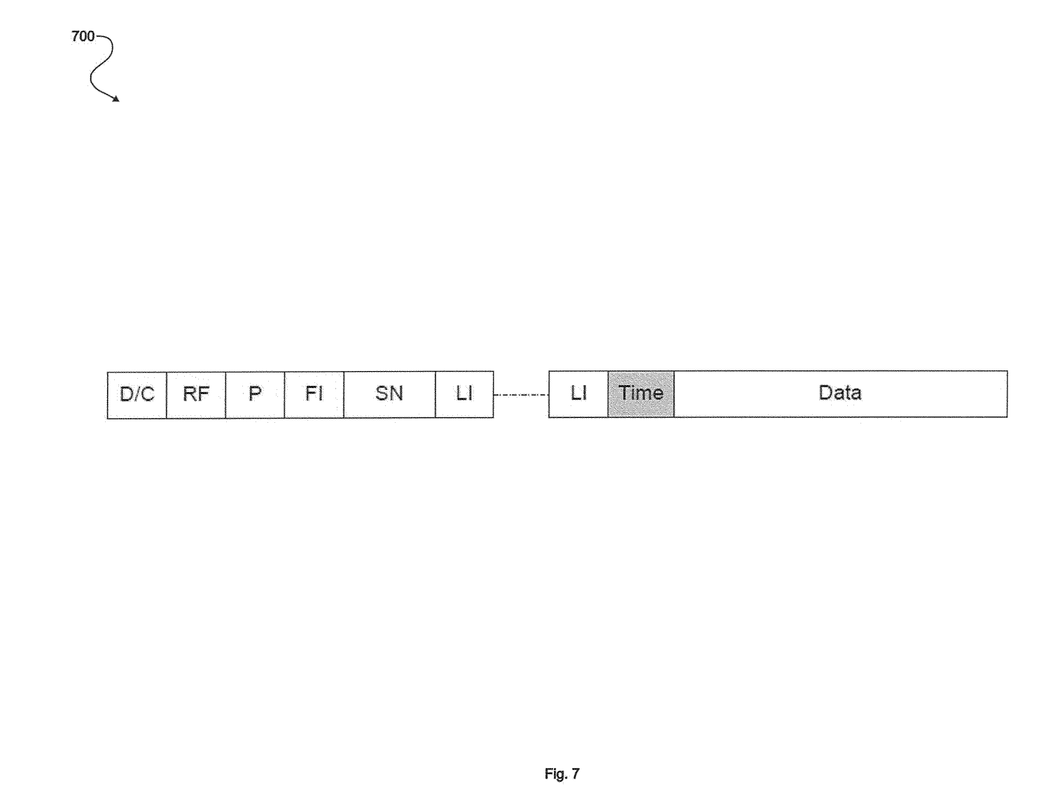

One or more embodiments of the invention also address mechanisms for latency determination that are designed to be carried out without a need for reporting by an AP and/or a UE. Such an approach can be accomplished using time stamps in radio link control packet data units (RLC PDU) which may be received in an uplink connection between the UE and the eNB. Switching may take place below the RLC, allowing LTE RLC packets to be delivered over WLAN radio. For example, for an acknowledge mode data (AMD) PDU, the PDU format with a time stamp may be as illustrated in FIG. 7. showing a PDU 700, The latency can be determined by comparing the received time against the timestamp.

Such an approach is also applicable to an interface between a WLAN AP and an LTE eNB, and in such a case, downlink latency information can also be obtained through this mechanism.

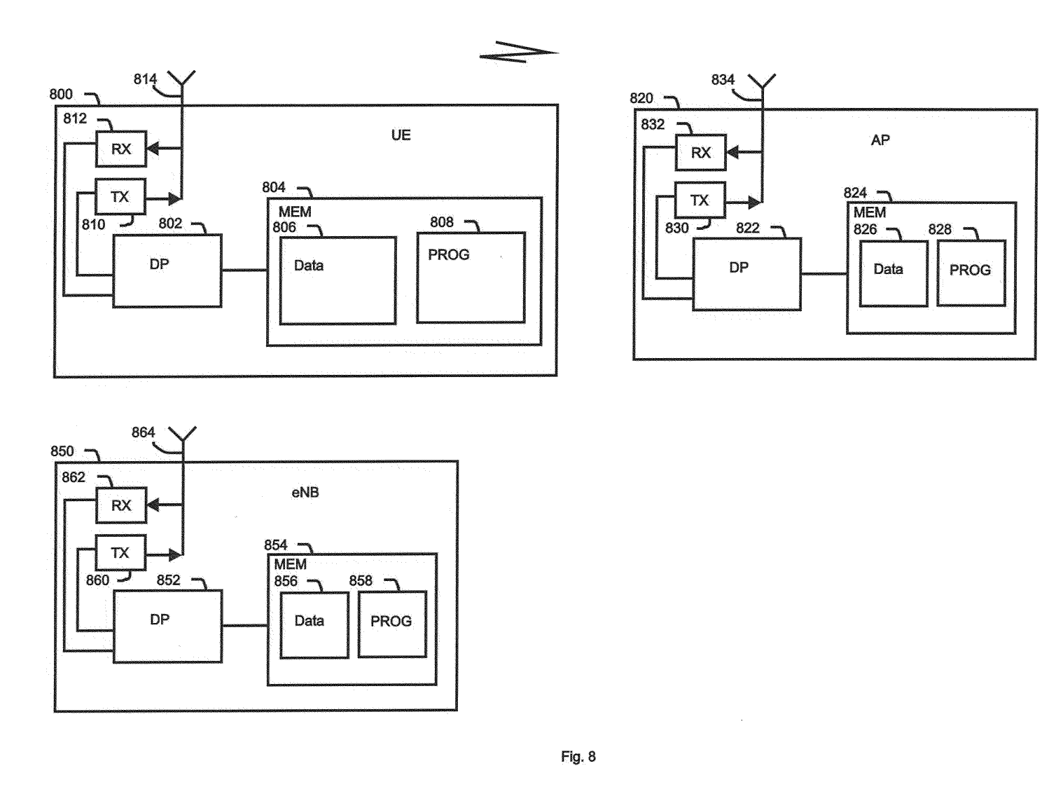

FIG. 8 illustrates an exemplary user device 800 according to an embodiment of the present invention, configured to act, for example, as a device controlled by a user subscribing to a network such as the network 300 or the network 500. The user device comprises a data processor 802 and memory 804, with the memory 804 suitably storing data 806 and software 808. The user device 800 further comprises a transmitter 810, receiver 812, and antenna 814. The software 806 stored in memory 804 includes program instructions (software (SW)) that, when executed by the associated data processor 802, enable the user device to operate in accordance with the exemplary embodiments of this invention. That is, the exemplary embodiments of this invention may be implemented at Least in part by computer software executable by the DP 802 of the, various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

FIG. 8 also illustrates an exemplary wireless access point 820, allowing communication by wireless communication devices which operated, for example, as part of a wireless local area network or a wireless cellular network.

The access point 820 comprises a data processor 822 and memory 824, with the memory 824 suitably storing data 826 and software 828. The access point 820 further comprises a transmitter 830. receiver 832, and antenna 836. The software 826 stored in memory 824 includes program instructions (software (SW)) that when executed by the associated data processor 822, enable the access point to operate in accordance with the exemplary embodiments of this invention. That is, the exemplary embodiments of this invention may be implemented at least in part by computer software executable by the DP 822 of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

FIG. 8 also illustrates an exemplary eNB 850, allowing communication by wireless communication devices which operated, for example, as part of a wireless local area network or a wireless cellular network.

The eNB 850 comprises a data processor 852 and memory 854, with the memory 854 suitably storing data 856 and software 858. The eNB 850 further comprises a transmitter 860, receiver 862, and antenna 866. The software 866 stored in memory 864 includes program instructions (software (SW)) that, when executed by the associated data processor 862, enable the eNB to operate in accordance with the exemplary embodiments of this invention. That is, the exemplary embodiments of this invention may be implemented at least in part by computer software executable by the DP 852 of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

The various embodiments of the user device 800 can include, but are not limited to, cellular phones, personal digital assistants (PDAs) having wireless communication capabilities, portable computers having wireless communication capabilities, image capture devices such as digital cameras having wireless communication capabilities, gaming dev ices having wireless communication capabilities, music storage and playback appliances having ireless communication capabilities, Internet appliances permitting wireless Internet access and browsing, as well as portable units or terminals that incorporate combinations of such functions.

In one or more embodiments, the access point 850 may provide means for receiving packet queuing latency information relating to data traffic between a user device and a wireless local area network access point and means for determining allocation of communication traffic to the wireless local area network access point based on the at least one packet queuing latency measurement.

In one or more embodiments, one or more of the user device 800 and the access point 820 may provide means for configuring measurement of packet queuing latency between a user device and a wireless local area network access point and means for causing transmission of measurement information to a base station.

The memories 804, 824, and 854 may be of any type suitable to the local technical environment and may be implemented using any suitable data storage technology, such as semiconductor based memory devices, flash memory, magnetic memory devices and systems, optical memory devices and systems, fixed memory and removable memory. The data processors 802, 822, and 852 may be of any type suitable to the local technical environment, and may include one or more of general purpose computers, special purpose computers. microprocessors, digital signal processors (DSPs) and processors based on multi-core processor architectures, as non-limiting examples.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

We claim:

1. An apparatus comprising:
at least one processor;
memory storing computer program code;
wherein the memory storing the computer program code is configured to, with the at least one processor, cause the apparatus to at least:
receive packet queuing latency information relating to data traffic between a user device and a wireless local area network access point; and
determine allocation of communication traffic to the wireless local area network access point based on the at least one packet queuing latency measurement.

2. The apparatus of claim 1, wherein the packet queuing latency information is based on a downlink measurement from the access point.

3. The apparatus of claim 1, wherein the packet queuing latency information is based on an uplink measurement from the user device.

4. The apparatus of claim 1, wherein the packet queuing latency information is based on an uplink measurement from the user device and a downlink measurement from the access point.

5. The apparatus of claim 1, wherein the packet queuing latency information is based on timing information relating to communication of a packet data unit having an embedded timestamp.

6. An apparatus comprising:
at least one processor;
memory storing computer program code;
wherein the memory storing the computer program code is configured to, with the at least one processor, cause the apparatus to at least:
configure measurement of packet queuing latency between a user device and a wireless local area network access point; and
cause transmission of measurement information to a base station.

7. The apparatus of claim 6, wherein measuring the packet queuing latency comprises measuring at least one of uplink and downlink latency by a user device and transmission of measurement information to the base station comprises transmission of measurement information to the base station by the user device.

8. The apparatus of claim 6, wherein measuring the packet queuing latency comprises measuring downlink latency by an access point and transmission of measurement information to the base station comprises transmission of measurement information to the base station by the access point.

9. A method comprising:
receiving packet queuing latency information relating to data traffic between a user device and a wireless local area network access point; and
determining allocation of communication traffic to the wireless local area network access point based on the at least one packet queuing latency measurement.

10. The method of claim 9, wherein the packet queuing latency information is based on a downlink measurement from the access point.

11. The method of claim 9, wherein the packet queuing latency information is based on an uplink measurement from the user device.

12. The method of claim 9, wherein the packet queuing latency information is based on an uplink measurement from the user device and a downlink measurement from the access point.

13. The method of claim 9, wherein the packet queuing latency information is based on timing information relating to communication of a packet data unit having an embedded timestamp.

14. A method comprising:
configuring measurement of packet queuing latency between a user device and a wireless local area network access point; and
causing transmission of measurement information to a base station.

15. The method of claim 14, wherein measuring the packet queuing latency comprises measuring at least one of uplink and downlink latency by a user device and transmission of measurement information to the base station comprises transmission of measurement information to the base station by the user device.

16. The method of claim 14, wherein measuring the packet queuing latency comprises measuring downlink latency by an access point and transmission of measurement information to the base station comprises transmission of measurement information to the base station by the access point.

17. A computer-readable medium storing a program of instructions, execution of which by a processor configures an apparatus to at least:
receive packet queuing latency information relating to data traffic between a user device and a wireless local area network access point; and
determine allocation of communication traffic to the wireless local area network access point based on the at least one packet queuing latency measurement.

18. The computer-readable medium of claim 17, wherein the packet queuing latency information is based on a downlink measurement from the access point.

19. The computer-readable medium of claim 17, wherein the packet queuing latency information is based on an uplink measurement from the user device.

20. The computer-readable medium of claim 17, wherein the packet queuing latency information is based on an uplink measurement from the user device and a downlink measurement from the access point.

21. The computer-readable medium of claim 17, wherein the packet queuing latency information is based on timing information relating to communication of a packet data unit having an embedded timestamp.

22. A computer-readable medium storing a program of instructions. execution of which by a processor configures an apparatus to at least:
configure measurement of packet queuing latency between a user device and a wireless local area network access point; and
cause transmission of measurement information to a base station.

23. The computer-readable medium of claim 22, wherein measuring the packet queuing latency comprises measuring at least one of uplink and downlink latency by a user device and transmission of measurement information to the base station comprises transmission of measurement information to the base station by the user device.

24. The computer-readable medium of claim 22, wherein measuring the packet queuing latency comprises measuring downlink latency by an access point and transmission of measurement information to the base station comprises transmission of measurement information to the base station by the access point.
